(19) United States
(12) Patent Application Publication
(10) Pub. No.: US 2016/0273260 A1
(43) Pub. Date: Sep. 22, 2016

(54) WATER RESISTANT DOOR THRESHOLD AND SYSTEM

(71) Applicant: Fenovation Limited, Debert (CA)

(72) Inventors: Joseph L. Jolie, North Bay (CA); James Bondy, Astroville (CA); Jeffrey C. Addison, Valley (CA); Vincent J. Maccormack, Truro (CA)

(21) Appl. No.: 14/659,412

(22) Filed: Mar. 16, 2015

(51) Int. Cl. E06B 1/70; E06B 7/23; E06B 7/14

(52) U.S. Cl. CPC E06B 1/70; E06B 7/14; E06B 7/2316

(57) ABSTRACT

The present invention provides a self-draining threshold assembly which comprises a sill cover for mounting on a sill support. A chambered covering attaches to the upper portion of the sill cover and includes an interior vertical wall, an exterior vertical wall, a lower member, an upper member and end caps, which define therein a reservoir chamber. There is an opening in the upper member of the chambered covering that receives liquid and sequesters it in the reservoir chamber. A weep hole in the exterior vertical wall of the chambered covering provides liquid communication between the reservoir chamber and the sill cover, and serves as an outlet for the sequestered liquid. The weep hole is elevated a predetermined distance above the sill cover to reduce backflow of liquid into the reservoir chamber. The threshold assembly may also comprise a deflector that attaches to the chambered covering, thereby physically shielding the weep hole from the external environment. Threshold extensions of various shapes and sizes can also be attached to the nose of the sill cover, which will allow the threshold assembly to accommodate a variety of door structures.

### FIELD OF THE INVENTION

The invention relates to entryway systems, and more particularly, to a self-draining water resistant door threshold and system.

### BACKGROUND OF THE INVENTION

Inswing doors, by virtue of their design, are often more prone to drafts and leakage than their outswing counterparts. An outswing door can utilize a jamb and compression gaskets in order to seal out water and air. In contrast, inswing doors are reliant on obtaining additional protection from outside elements through the threshold. A basic threshold (see for example FIG. 1) is often composed of wood or aluminum and typically has at least one upward projecting portion that contacts the bottom portion of a door in order to provide a physical barrier. Often the door and/or the threshold have additional features to enhance the strength of the physical barrier, such as a sweep or a rubber seal. The basic functions of the threshold are to provide an additional barrier to minimize or eliminate the passage of water or air into the building.

In certain geographical regions, such as coastal areas, additional protection at entryways is warranted and necessary as high rainfall levels, driving rains, tropical storms etc. test the limits of these barriers. Under the conditions associated with thunderstorms, hurricanes etc., high winds bombard the door with rain at excessive forces that often result in penetration of water, with the point of entry typically being the interface between the door and the threshold. An elevated positive pressure created by such weather conditions on the exterior of the door also contributes to forcing water and/or air through the door-threshold interface. In the instance of self-draining thresholds, strong weather conditions can force water and/or air to breach the entryway through the threshold itself.

There have been numerous attempts in the prior art to create a threshold that has improved resistance to water and/or air penetration, including the following.

U.S. Pat. No. 7,669,369 discloses a door threshold water return system comprising a lower sill; an upper sill; a rear wall; and a front wall forming a chamber, wherein at least one baffle is provided projecting into the chamber from the rear wall, a first gap is provided in proximity to the rear wall and between the upper sill and the rear wall, and a second gap is provided in proximity to the lower sill and between the lower sill and the front wall, whereby water introduced into the system through the first gap exits the system through the second gap.

U.S. Pat. No. 8,448,384 discloses a doorway with a sill attachment that includes a sill, which is a substantially hollow contain-and-drain type sill with a nosing provided with drainage openings. A substantially hollow sill attachment is mounted to and extends along the nosing and the attachment projects downwardly to a position below the openings in the nosing of the sill. The drainage openings communicate with the interior of the extension. Weep holes that communicate with the environment are located in the sill attachment at a position below the openings in the nosing of the sill.

U.S. Pat. No. 5,067,279 discloses a self-draining door threshold, which includes a wedge-shaped silicone check valve in communication with a water reservoir on the interior side. The check valve is normally closed but will open in response to water pressure which overcomes the resilience of the silicone material and the air pressure on the top wall of the wedge-shaped passageway. The check valve functions as a seal against incoming air but will open to allow escape of water as needed. The silicone material seals around foreign material in the valve making it air tight.

U.S. Pat. No. 8,033,056 discloses a doorway with an anti-bubbling sill drain, which includes an outside nosing provided with weep holes and weep doors and a threshold portion that directly underlies a closed door mounted in the frame. A drain insert is mounted within the threshold portion of the sill for allowing water collected on the threshold portion to drain into the sill and for allowing air within the sill to vent.

U.S. Pat. No. 7,600,346 discloses a threshold assembly which includes a sill having a first wall extending upwardly from the proximate end of an entry portion and a second wall extends upwardly from the sill and along the first wall to define a channel extending longitudinally between jamb pedestals. The first wall defines an opening which establishes fluid communication from the channel to the entry portion of the sill between the jamb pedestals for directing water from the channel away from the threshold assembly along the entry portion.

U.S. Pat. No. 5,179,804 discloses a self-draining door sill assembly for use in the bottom of an exterior door frame of a house. The assembly includes a threshold and base that define an elongated water chamber therebetween and the threshold defines an upwardly opening storm drain channel formed in and along an upper, interior side surface portion thereof which terminates in a pair of slots located in opposite ends of the threshold, which slots also communicate with the underlying water chamber. A pair of spaced apart weep channels are formed in the base and extend from a floor of the water chamber along the exterior side of the base, such that rain water which blows or seeps past the primary seal gathers in the drain channel, flows through the slots onto the floor of the water chamber, migrates along the floor to the weep channels, and then flows through the weep channels out of the assembly.

U.S. Pat. No. 5,136,814 discloses a draining threshold and door sill assembly, having an elongated frame member forming an upwardly open channel and a sill that slopes away from the channel. A threshold cap is removably captured within the channel and protrudes slightly thereabove. An end cap is securely fastened to an end of the assembly and is formed with a drain trough that extends transversely beneath the end of the assembly. Rain water that seeps under the threshold cap and into the channel flows to the end of the channel and into the drain trough of the end cap, which directs the water beyond the outside edge of and away from the assembly.

In light of the door threshold systems described above, a need still exists for an easily modifiable door threshold with improved air and water resistance that typically exceeds building code performance requirements.

### SUMMARY OF THE INVENTION

According to an aspect of the present invention, there is provided a self-draining threshold assembly comprising a threshold cover for mounting on a threshold support; a chambered covering attached to the upper portion of the threshold cover, the chambered covering comprising an interior vertical wall, an exterior vertical wall, a lower member, an upper member and end caps, that define therein a reservoir chamber, and the chambered covering having an opening in the upper member to receive liquid; a weep hole in the exterior vertical wall of the chambered covering that provides for liquid communication between the reservoir chamber and the sill cover, the weep hole being elevated a predetermined distance above the sill cover.

The threshold assembly may also comprise a deflector that attaches to the chambered covering, thereby physically shielding the weep hole. Deflectors may vary in shape and size in order to provide a range of leakage protection to the assembly. Preferably the upper surface of the chambered covering is elevated a predetermined distance above the upper surface of the deflector.

It is preferred that the sill cover slope downward and away from the door-threshold interface. At the end of the threshold support, the sill cover can extend downward to produce a blunted nose to the assembly, or alternatively, threshold extensions of various shapes and sizes can be attached to the sill cover. The ability to modify the assembly, such as through interchanging deflectors and/or threshold extensions provides a versatile product.

According to a further aspect of the present invention, there is provided a water resistant threshold system comprising a self-draining threshold assembly according to the present invention; at least one sweep for mounting on the lower portion of a door; at least one primary seal for mounting on the lower portion of the door to come into frictional contact with the upper surface of the chambered covering; and at least a primary weather seal to facilitate a seal between the door and jamb interface.

According to another aspect of the present invention, there is provided a doorway comprising two opposing side jambs spaced apart by an upper head jamb; a door panel swingably mounted within the side jambs and head jamb; and a self-draining threshold assembly according to the present invention mounted between the lower portion of the side jambs.

### BRIEF DESCRIPTION OF THE DRAWINGS

The present invention will now be described in more detail having regard to the drawings in which:

FIG. 1 is a cross-sectional view of a known inswing door threshold;

FIG. 2 is a cross-sectional view of a water resistant door threshold system according to an embodiment of the present invention;

FIG. 3 is a cross-sectional view of the threshold assembly according to an embodiment of the present invention;

FIGS. 4A-4G are cross-sectional views of threshold covers and threshold extensions according to multiple embodiments of the present invention; and

FIG. 5 is a cross section view of a mounted door from the water resistant door threshold system according to an embodiment of the present invention.

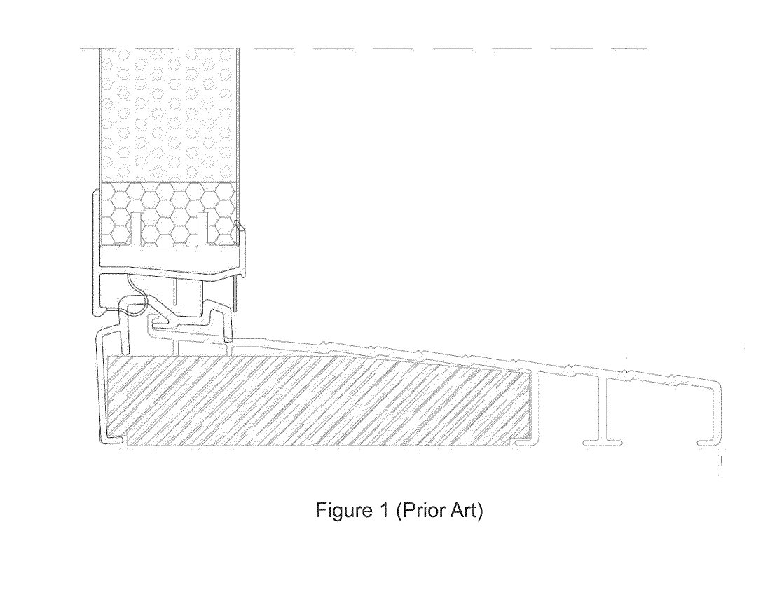

### DETAILED DESCRIPTION OF THE INVENTION

A better understanding of the present invention and its objects and advantages will become apparent to those skilled in this art form the following detailed description, wherein there is described only the preferred embodiment of the invention, simply by way of illustration of the best mode contemplated for carrying out the invention. As will be realized, the invention is capable of modifications in various obvious respects, all without departing from the scope and spirit of the invention. Accordingly, the description should be regarded as illustrative in nature and not as restrictive.

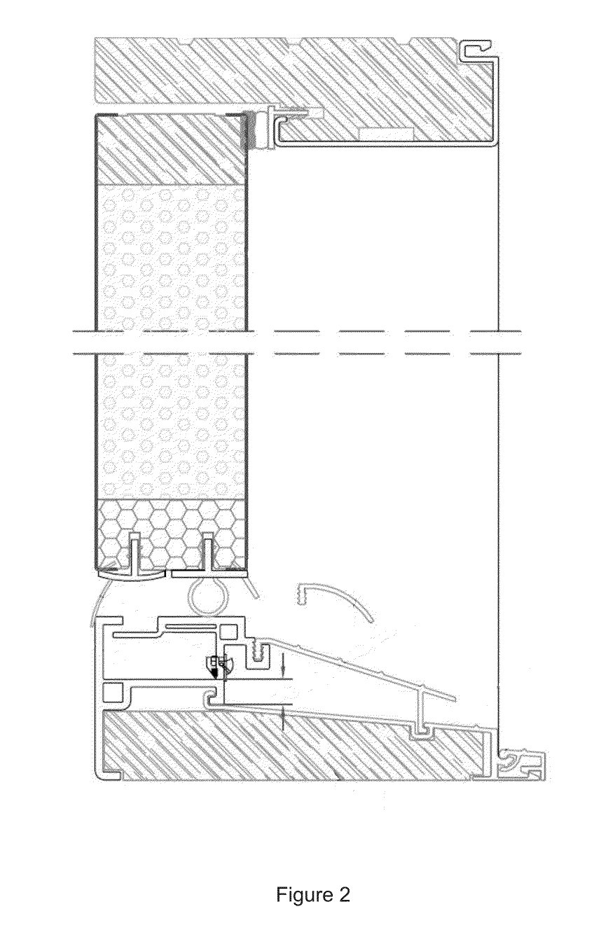

The Figures illustrates a water resistant door threshold system 1 according to an embodiment of the present invention. As shown in FIGS. 2 and 3, the water resistant door threshold system 1 comprises a door 2, a threshold assembly 3, as well as additional sealing means, such as interior and exterior sweeps 5 and/or primary seal 7.

According to one embodiment of the invention as shown in FIG. 3, the threshold assembly 3 comprises a threshold cover 9 that is attached to and covers a threshold support 11. It is preferable that the threshold cover 9 slopes downwardly away from the door-threshold interface 13 in order to direct water away from the interior of the building A. The threshold cover 9 is preferably aluminum or some other material that is durable and resistant to the penetration of water. The length and width of the threshold cover 9 may vary as necessary in order to accommodate different threshold supports 11 that may be routinely used in the construction of entranceways.

Extending upward from the interior portion of the threshold support 11 is a chambered covering 15 that extends the length of the threshold support 11. The chambered covering 15 comprises interior 17 and exterior 19 vertical walls that combine with an upper member 21, a lower member 23 and end caps (not shown) to define a reservoir chamber 25 that preferably extends the length of the threshold support 11. The chambered covering 15 may be integral with the threshold cover 9, or alternatively, the chambered covering 15 may be a separate piece that attaches to the threshold cover 9 through e.g. a snap fit connection, male-female connectors etc. The use of separate pieces increases the flexibility of the assembly 3 by allowing for interchangeability of threshold covers 9 with different chambered coverings 15.

The interior vertical wall 17 is preferably secured to the threshold support 11 at its lower end, such as through a first foot 27 or other connecting member extending inwardly from the interior vertical wall 17, which aids in securing the chambered covering 15 to the threshold support 11. A lip 29 extends inwardly at the top portion of the interior vertical wall 17 to form part of the upper member 21. The remainder of the upper member 21 is formed by a substantially horizontal extension 33 from the upper portion of exterior vertical wall 19. The extension 33 and the lip 29 form an opening 31 in the upper member 21 that serves to capture water before it penetrates the threshold assembly 3.

According to one embodiment as can be seen in FIG. 3, inside the chamber at least one baffle 35 extends from the extension 33 toward the interior vertical wall 17. Although in another embodiment, the baffle 35 may extend from the interior vertical wall 17 or the lip 29 toward the exterior vertical wall 19. Any water that penetrates the sweep 5 and the primary seal 7 will be substantially captured by the opening 31 and directed by the baffle 35 into the reservoir chamber 25. The width of the baffle 35 may vary, but is preferably equivalent or greater to the width of the opening 31.

Preferably, the lower member 23 of the chambered covering 15 is elevated a predetermined distance above the threshold cover/threshold support 9,11. In one embodiment, there is a void space 37 between the lower member 23 and the threshold cover/threshold support 9,11, however, this space 37 may be filled with solid material or at least one vertical support in order to structurally strengthen the chambered covering 15. As can be seen in FIG. 3, there is a void space 37 under the lower member, but in this embodiment, there is an additional support structure 39 that communicates between the lower member 23 and the interior vertical wall 17. This support structure 39 also facilitates securing the chambered covering 15 to the threshold support 11, particularly when the threshold support 11 is in a snug fit between the first foot 27 and the support structure 39.

Within the exterior vertical wall 19, there is a weep hole 41 that provides for controlled liquid communication between the reservoir chamber 25 and the external environment. The weep hole 41 may be continuous and extend along the length of the chambered covering, i.e. from side jamb to side jamb along the width of the doorway, or alternatively, there may be a plurality of weep holes 41 of any particular size that are located at certain distances along the exterior vertical wall 19 of the chambered covering 15. The elevation of the lower member 23 of the chambered covering 15 creates a weep hole drop y between the weep hole 41 and the threshold cover 9. Water that breaches the sealing means (e.g. sweep 5 and/or primary seal 7) between the bottom of the door 2 and the chambered covering 15 will flow through the opening 31 and become trapped in the reservoir chamber 25. The water is then able to vent through the weep hole 41, down the weep hole drop y onto the threshold cover 9 where it runs off the threshold assembly 3. The weep hole drop y is substantially vertical, however, it is possible that the weep hole drop y is sloped downward to the threshold cover 9.

In one embodiment, the weep hole 41 is gated, and is biased to the closed position. For example, the gated weep hole 41 could be a type of check valve, such as a ball check valve, a diaphragm check valve, a swing check valve, a stop-check valve, a lift-check valve, an in-line check valve or a duckbill valve. Any other type of covering for the rain gate is contemplated, provided that under a certain pressure it yieldably releases to allow flow in one direction, while minimizes or eliminates flow in the opposing direction. In this embodiment, a predetermined amount of water is required in the reservoir chamber before the gated weep hole 41 reverts to an open position, at which time the collected water can vent through the weep hole 41, down the weep hole drop y onto the threshold cover 15 where it runs off the threshold assembly 3. The gated weep hole 41 provides additional protection against water leakage, as under certain weather conditions, such as strong winds and driving rain, water and/or air may penetrate an ungated weep hole 41. Once in the reservoir chamber 25, the water and/or air could pass up through the opening 31 and into the interior of the building A. The nature of the gated weep hole 41 would minimize the entry of water and/or air from the external environment into the reservoir chamber 25, even under conditions of strong wind, driving rain and elevated pressure.

The weep hole drop y provides further resistance to the backflow of water into the reservoir chamber 25. During rainfall, rainwater that hits the sloped threshold cover 9 will typically drain away from the chambered covering 15. However, large precipitation levels can cause the accumulation of water on the threshold cover 9, potentially placing additional pressure on the weep hole 41. This added pressure increases the probability of a breach of the weep hole 41. The existence of the weep hole drop y requires that the water will need to rise substantially vertically at least the predetermined distance y before it is able to exert additional pressure on the weep hole 41. Reducing additional pressure on the gated weep hole 41 by deterring the buildup of external water may also prolong the functionality of the valve. The height of the weep hole drop y is not limiting, but it is preferred that it be at least 3/16 of an inch in order to provide a desirable deterrent to the backflow of water. Smaller or larger heights of the weep hole drop y will likely provide less or more of a deterrent to the backflow of water, respectively.

In one embodiment of the present invention, the threshold assembly 3 includes at least one deflector 43, that enhances resistance to air and water leakage when installed on the assembly 3. Ideally the assembly 3 comprises a plurality of interchangeable deflectors 43 of differing shapes and sizes that are installed based upon the water and resistance needs. The deflector 43 comprises a first end 45, a second end 47 and a shield portion 49, that acts as a physical shield which preferably provides some protection for a portion of the threshold cover 9, the exterior vertical wall 19 and/or the weep hole 41, such as by physically shielding these components from direct assault by wind and rain. This will further minimize or reduce any potential backflow of water and/or air through the weep hole 41, and may increase the longevity and functionality of the gated weep hole 41. The deflectors 43 primarily extend outward and downward from the chambered covering 15. They may be integral with the chambered covering 15, but preferably, the deflector 43 is removably attached thereto, such as by a snap fit connection, thereby allowing for a plurality of deflectors 43 to be interchanged in the assembly 3 as required. Depending upon the size and/or shape of the deflector 43, varying degrees of additional protection can be attained.

As is illustrated in one embodiment shown in FIGS. 2 and 3, a connector 51 extends outwardly from the exterior vertical wall 19 to detachably receive the deflector 43. According to one aspect of the present invention, multiple deflectors 43 of varying sizes and shapes can be designed have a mating connector 53 at a first end 45 thereof for removeable attachment to the connector 51. For example, FIG. 3 illustrates a small deflector 43 that is arcuate in shape, that when removeably attached to the connector 45, the shield portion 49 thereof curves outward and downward toward the threshold cover 9. Alternatively, a large deflector 43 has a substantially linear shield portion 49, that when removeably attached to the connector 51, extends outward from the exterior vertical wall 19 and gradually slopes downward ending near the nose of the threshold cover 9.

The second end 47 of the deflector 43 may contact the threshold cover 9, but may also hover just above. Contacting the threshold cover 9 may comprise resting the second end 47 on the threshold cover 9, in which case driving rain could still be forced therebetween. Or alternatively, the second end 47 of the deflector 43 can be attached to the threshold cover 9, removeably or otherwise. For example, the second end 47 of the deflector 43 may attach directly to the threshold cover 9, such as through a snap fit connection, or as illustrated with the large deflector, a deflector leg 55 may extend downwardly from the deflector 43 and contact the threshold cover 9. The deflector leg 55 may attach directly to the threshold cover 9, such as through a snap fit connection, or the deflector leg 55 may have a deflector foot 57 or other mating connector at its connecting end that, e.g. engages with a channel 59. Anchoring the deflector leg 55 further minimizes penetration of water through the threshold assembly 3, as wind and rain will not have direct access to the weep hole 41, thereby limiting any potential backflow through the weep hole 41.

By virtue of the nature of the assembly, the deflector will receive compression forces through foot traffic, and therefore, additional legs may be provided between the first and second ends of the deflector 43, in order to provide further structural support.

According to one embodiment, the deflector leg 55 will have at least one deflector leg weep hole (not shown), particularly when the deflector leg is removeably attached to the threshold cover. The deflector leg weephole will allow water draining from the reservoir chamber 25 through the weep hole 41 to flow down and off the threshold cover 9.

Preferably the deflector 43 does not extend outwardly such that the shield portion 49 is initially on plane with the top surface of the upper member 21 of the chambered covering 15. As shown in FIG. 3, it is preferred that that deflector 43 (or the connector 51 that removeably attaches the deflector 43) extends outwardly from the exterior vertical wall 19, creating a deflector drop x from the top surface of the upper member 21 of the chambered covering 15 to the deflector/connector 43,51. If the deflector 43 was initially on plane with the upper surface of the chambered covering 15, wind driven rain could be pushed directly up the deflector 43, past the sweep 5 and the primary seal 7. Such a volume of water could overwhelm the drainage system present in the chambered covering 15. The existence of the deflector drop x ensures that water driven up the deflector 43 by wind is not directly pushed into the door-threshold interface 13, but rather the water will abut against the front face of the exterior vertical wall 19. The water level will need to rise substantially vertically at least the predetermined distance x before it is able to exert additional pressure on and/or breach the sweep 5 and primary seal 7. The deflector drop x is substantially vertical, however, it is possible that the deflector drop x is sloped downward. The height of the deflector drop x is not limiting, but it is preferred that it be at least 3/16 of an inch in order to provide a desirable deterrent to the run up of water through the door-threshold interface 13. Smaller or larger heights of the deflector drop x will likely provide less or more of a deterrent, respectively.

In one embodiment, the threshold cover 9 extends downward to form a nose cover 61 on the front portion of the threshold support 11. Preferably, the threshold cover 9 at least partially envelops the front nose of the threshold support 11 in order to secure the threshold cover 9 thereon. This may provide a flat blunted finish to the threshold assembly 3, however, in another embodiment, the threshold cover 9 may extend outward, gradually or otherwise, to provide a tapered finish to the threshold cover until it meets the ground.

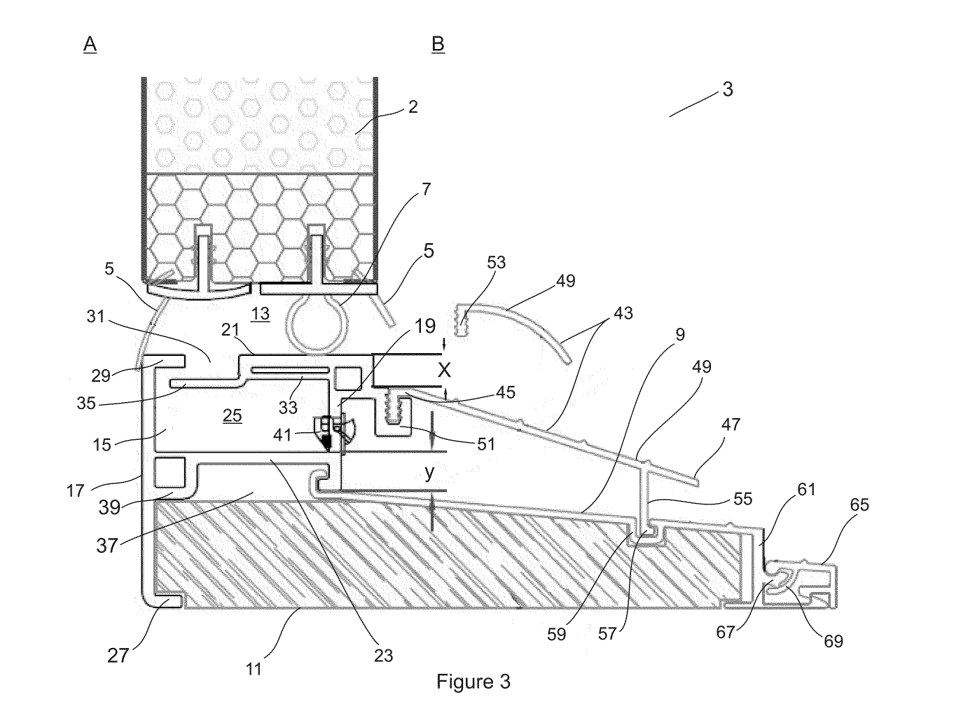

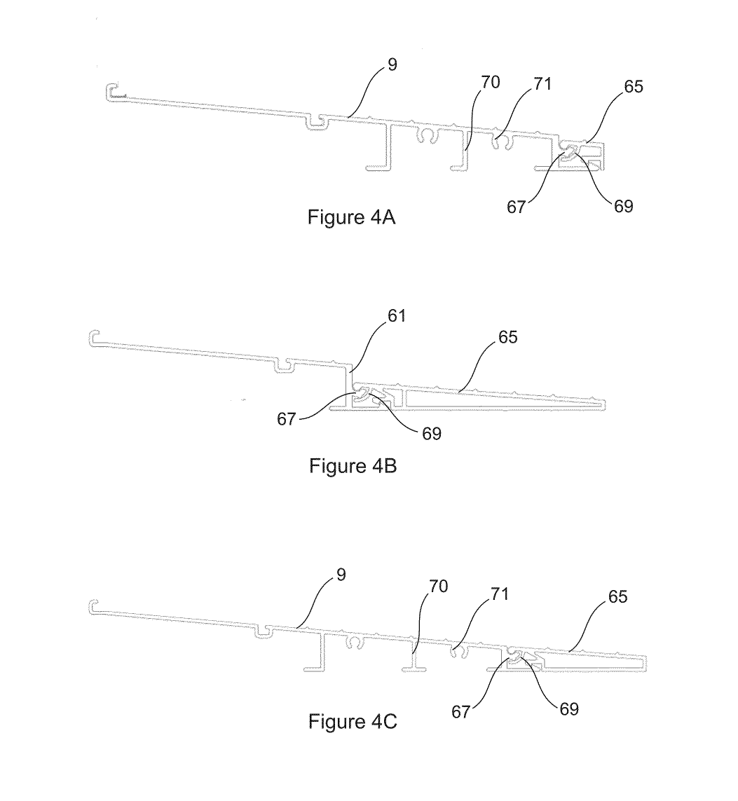

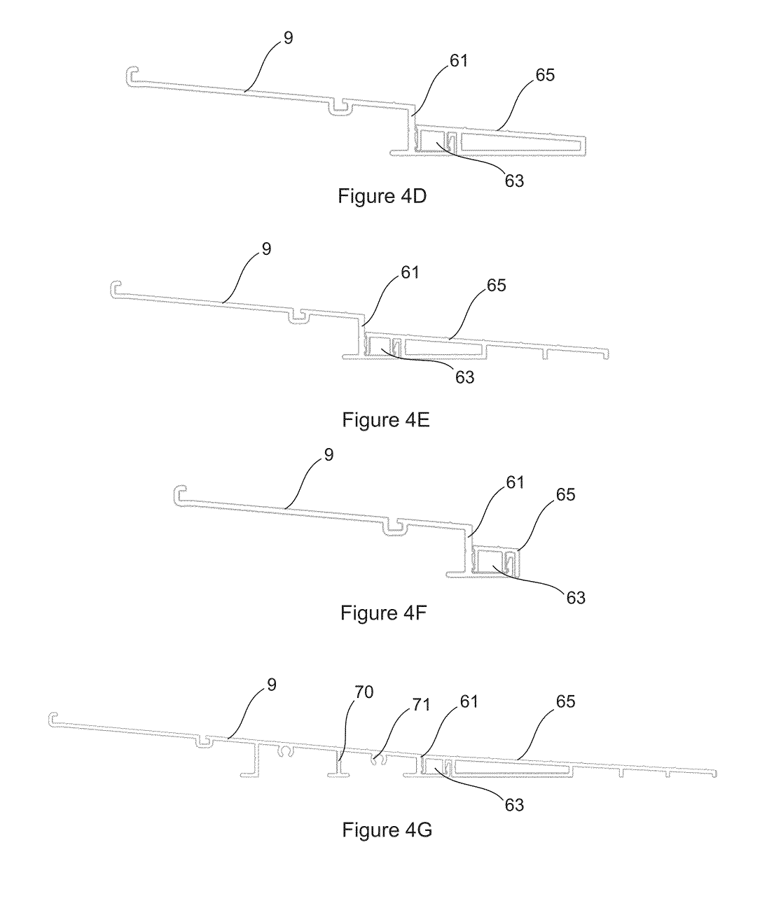

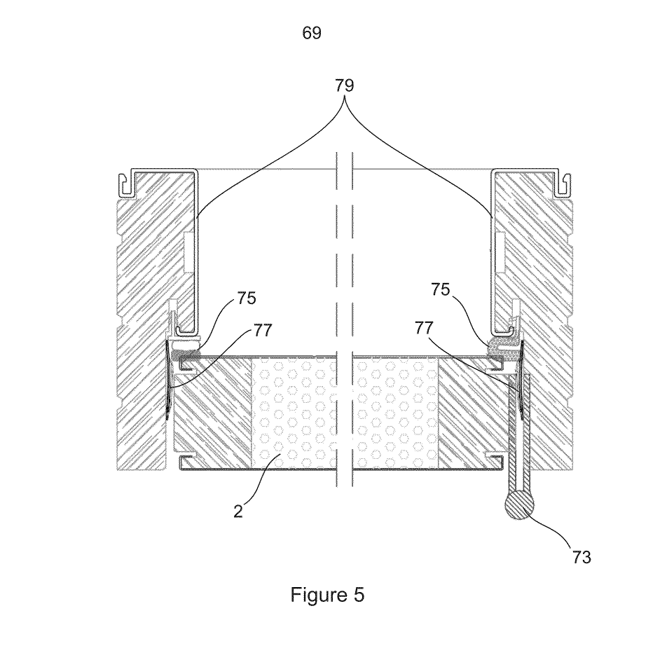

Alternatively, as shown in FIG. 3, the front face of the nose of the threshold cover 9 may have attachment means 63 that allow for the attachment of threshold extensions 65 of differing sizes and lengths (see FIGS. 4A-4G). These Figures illustrate the attachment of threshold extensions 65 to the front of the threshold cover 9 by way of snap fit means, although other means of attaching a threshold extension to the threshold cover are also contemplated. For example, as shown in FIGS. 4A to 4C, at least one connector 67, such as a male connector, extends outwardly from the front face of the nose of the threshold cover 9. Complementary extension connectors 69 in the threshold extension 65 receive or snap into the connector 67, providing for a snug fit of the threshold extension to the front of the threshold cover. The ability to interchangeably attach threshold extensions 65 of differing sizes to the threshold cover 9 will allow for the manufacture of a versatile single design of the threshold assembly 3 that can be tailored to fit a specific environment or need. These Figures also illustrate variations in the size and shape of the threshold cover 9 that are contemplated. The threshold cover 9 may have at least one additional sill cover leg 70 in order to provide further support and stability. Screw bosses 71 can also be added to the underside of the threshold cover 9, which will facilitate the attachment of the threshold cover 9 to the threshold support 11.

The threshold assembly 3 of the present invention may also be combined with additional features to provide a system. For example, the threshold assembly may be combined into a kit that further includes at least one of: at least one sweep 5 for mounting on the bottom portion of exterior and/or interior of the door; at least one primary seal 7 that attaches to the bottom of the door and physically contacts the threshold assembly to form a seal; primary and/or secondary weather stripping 75,77 that can be added either to the door or to the side jamb 79, head jamb or hinge 73 as needed to further enhance the leakage protection of the doorway. The components are not particularly limiting, and would be well known to one of skill in the art.

The threshold assembly 3 can also be incorporated into e.g. a prefabricated door system. In such an embodiment, a typical doorway has been constructed comprising two opposing side jambs, a head jamb and the threshold support 11. The threshold assembly 3 is already mounted onto the threshold support 11. A door may or may not already be hingedly mounted to the doorway.

### EXAMPLES

Structural and functional testing of windows and doors is performed in order to achieve a rating that signifies how these products are able to perform under various weather conditions, such as during tropical storms and hurricanes. Many building codes, such as those present in coastal areas, now require such testing, and often require products to reach certain standards and requirements prior to approval for use in building construction.

An inswing entry door utilizing a threshold assembly 3 according to the present invention was produced and was subjected to certain standardized tests in order to observe and assess performance.

### Air Leakage Resistance

Two mock-ups of the threshold assembly according to the present invention were subject to testing in accordance with ASTM E 283. The assembly was subjected to an air pressure of 75 pascals in both a positive and negative direction perpendicular to the plane of the unit. The amount of air permeating the test unit (air leakage) is recorded in the positive and negative directions.

As a result of the above noted test pressures, the test specimen exhibited air leakage rates as shown in the following tables, which would place the ability of the threshold assembly to prevent or minimize air leakage well above minimum requirements.

TEST UNIT 1

| | Air Leakage Rate (L/s/m²) |
|---|---|
| First Test | 0.046 |
| Second Test | 0.057 |
| Third Test | 0.044 |
| Average | 0.049 |

TEST UNIT 2

| | Air Leakage Rate (L/s/m²) |
|---|---|
| First Test | 0.031 |
| Second Test | 0.031 |
| Average | 0.031 |

### Water Leakage Resistance

Two mock-ups of the threshold assembly according to the present invention were subject to testing in accordance with ASTM E 547. The assembly was subject to a four-cycle water test. Each cycle consists of five minutes with a positive pressure applied to the exterior of the door followed by one minute where the pressure has been released, during which a continuous water spray (5 US gal/ft²/hr) is applied to the exterior. The interior of the door is monitored for any water leakage. Each successive test is performed at a specified pressure that ultimately dictates the design pressure (DP) designation for a unit. The highest test pressure that an assembly passes relates to the DP designation that is afforded to an assembly.

As a result of the above noted test pressures, the test specimens obtained DP ratings as shown in the following table, which would place the ability of the threshold assembly to prevent or minimize water leakage well above minimum requirements.

TEST UNIT 1

| | DP RATING |
|---|---|
| First Test | DP 75 (540 Pa) |
| Second Test | DP 100 (730 Pa) |

TEST UNIT 2

| | DP RATING | Notes |
|---|---|---|
| First Test | DP 100 (730 Pa) | |
| Second Test | DP 95 (690 Pa) | Faulty Sweep On Door |
| Third Test | DP 100 (730 Pa) | |
| Fourth Test | DP 25 (180 Pa) | No Deflector Used |
| Fifth Test | DP 50 (360 Pa) | Small Deflector Used |

The embodiments of the present invention in which an exclusive property or privilege is claimed are defined as follows:

1. A door threshold assembly comprising:
a threshold cover for mounting on a threshold support;
a chambered covering at the upper portion of the threshold cover, the chambered covering comprising an interior vertical wall, an exterior vertical wall, a lower member, an upper member and end caps, that define therein a reservoir chamber, and the chambered covering has an opening in the upper member to receive liquid; and
a weep hole in the exterior vertical wall of the chambered covering that provides for liquid communication between the reservoir chamber and the threshold cover, the weep hole being elevated a predetermined distance above the threshold cover.

2. The door threshold assembly according to claim 1, wherein the interior vertical wall extends downward below the reservoir chamber, and the lower portion of the interior vertical wall has a connecting member for securing to the threshold support.

3. The door threshold assembly according to claim 1, wherein a baffle extends from an interior portion of the chambered covering to cover at least a portion of the opening in the upper member.

4. The door threshold assembly according to claim 1, wherein at least one support member extends downwardly from the reservoir chamber to support the reservoir chamber on the threshold support, and to elevate the weep hole a predetermined distance above the threshold cover.

5. The door threshold assembly according to claim 1, comprising a plurality of the weep holes at predetermined distances along the length of the chambered covering.

6. The door threshold assembly according to claim 1, wherein the weep hole is a channel that extends along the length of the chambered covering.

7. The door threshold assembly according to claim 1, wherein the exterior vertical wall between the weep hole and the threshold cover is substantially vertical.

8. The door threshold assembly according to claim 1, wherein the weep hole is gated with a one way check valve.

9. The door threshold assembly according to claim 1, further comprising:
a deflector releasably attached to the chambered covering, the deflector comprising a first end, a second end and a shield portion;
wherein the deflector extends outward and downward form the chambered covering.

10. The door threshold assembly according to claim 9, wherein the exterior vertical wall comprises a connector that receives and secures the first end of the deflector.

11. The door threshold assembly according to claim 10, wherein the top surface of the upper member is elevated a predetermined distance above the connector.

12. The door threshold assembly according to claim 10, wherein the exterior vertical wall between the connector and the top surface of the upper member is substantially vertical.

13. The door threshold assembly according to claim 9, wherein the shield portion is arcuate or flat.

14. The door threshold assembly according to claim 9, wherein the second end of the deflector terminates at or near the threshold cover.

15. The door threshold assembly according to claim 9, wherein the second end of the deflector connects with the threshold cover.

16. The door threshold assembly according to claim 15, wherein there is at least one drain hole near the second end of the deflector.

17. The door threshold assembly according to claim 9, wherein a support leg extends downward from near the second end of the deflector, and the support leg rests on or connects with the threshold cover.

18. The door threshold assembly according to claim 17, wherein there is at least one drain hole in the support leg.

19. The door threshold assembly according to claim 1, further comprising:
a threshold extension that releasably attaches to the threshold cover at the front of the threshold support, the threshold extension extends outward and downward.

20. A water resistant threshold system comprising:
a self-draining threshold assembly according to claim 1;
at least one sweep for mounting on the lower portion of a door;
at least one primary seal for mounting on the lower portion of the door to come into frictional contact with the upper surface of the chambered covering; and
at least a primary weather seal to facilitate a seal between the door and jamb interface.

21. A doorway comprising:
two opposing side jambs spaced apart by an upper head jamb;
a door panel swingably mounted within the side jambs and head jamb; and
a door threshold assembly according to claim 1 mounted between the lower portion of the side jambs.
